(19) United States
(12) Patent Application Publication
(10) Pub. No.: US 2017/0339951 A1
(43) Pub. Date: Nov. 30, 2017

(54) A Method of Controlling Microbial Pathogens on Living Plant Tissue

(71) Applicant: Akzo Nobel Chemicals International B.V., Arnhem (NL)

(72) Inventors: Martinus Catharinus TAMMER, Diepenveen (NL); Bart FISCHER, Leusden (NL)

(21) Appl. No.: 15/520,994

(22) PCT Filed: Oct. 26, 2015
(86) PCT No.: PCT/EP2015/074693

§ 371 Date: Apr. 21, 2017

(30) Foreign Application Priority Data
Oct. 28, 2014 (EP) 14190633.9

(51) Int. Cl. A01N 37/16; A01N 59/00; A01N 25/02

(52) U.S. Cl. CPC A01N 37/16; A01N 25/02; A01N 59/00

(57) ABSTRACT

A method of controlling microbial pathogens on living plant tissue comprising treating said plant tissue with an aqueous formulation comprising a diacyl peroxide and a hydroperoxide selected from hydrogen peroxide and organic hydroperoxides.

The invention relates to a method for controlling microbial pathogens on living plant tissue.

In the production of fruits and vegetables, the growing plants, the seeds, seedlings, and fruit suffer from attack by microorganisms such as bacteria and fungi. The use of fungicides in agriculture is necessitated by the great losses caused by a wide variety of plant-pathogenic microorganisms.

As explained in WO 99/51095, fungicides are typically applied in aqueous suspension with hydraulic sprayers or in the form of dust, granules or fumigants. Early fungicides included sulfur and polysulfides, heavy metals and others. Such harsh fungicides have been replaced by newer but still toxic materials such as quinones, organosulfur compounds, imidazolines and guanidines, trichloromethylthiocarboximides, chlorinated and nitrated benzenes, oxithines, benzimidazoles, pyrimidines, and others. These broad spectrum protectant materials affect enzyme and membrane systems of the target microorganism. Typically, the mode of action includes inhibition of fungal or bacterial energy production, interference with biosynthesis or disruption of cell membrane structure. The above fungicides have had some success; however, they are viewed as toxic materials and a substantial quantity of plants are wasted due to their deleterious effect.

The above prior art document provided a method of controlling the organisms using an aqueous solution comprising a C₂-C₄ peroxycarboxylic acid and an aliphatic C₈-C₁₂ peroxycarboxylic acid, more in particular a solution comprising peroxyacetic acid and peroxyoctanoic acid.

Human and plant pathogenic bacteria and fungi can be a contamination problem in growing plants. Coli forms, salmonella, and other bacteria common in the agricultural and greenhouse environment can contaminate growing plants and pose a threat to human health in consumption of fresh vegetables and fruit. A substantial need exists for treatments that can reduce bacterial contamination.

Peroxyacids are already known to be suitable biocides; see EP 0 233 731, GB 2,187,958, and EP 0 242 990, WO 94/06294, U.S. Pat. No. 5,168,655 U.S. Pat. No. 5,200,189, U.S. Pat. No. 2,512,640, and GB 2257630.

Especially in potato and tomato farming, Phythophthora Infestants (Late Blight) and Silver scurf are a major problem. In grapevine pharming, Plasmopara Viticola (Downey Mildew) is one of the problematic diseases.

DD 298 591 discloses the use of a (substituted) dibenzoyl peroxide as fungicide. In particular, it discloses dibenzoyl peroxide, p,p′-dimethylbenzoyl peroxide, p,p′-dimethoxybenzoyl peroxide, p,p′-dinitrobenzoyl peroxide, p,p′-dichlorobenzoyl peroxide, and p-chlorobenzoyl-benzoyl peroxide.

It has now been found that, compared to the use of peroxyacid solutions or the use of (substituted) benzoyl peroxide suspensions, the protection of plants against microbial organisms can be further improved by using a mixture of a diacyl peroxide and a hydroperoxide.

The mixture is particularly suitable to protect potato and tomato plants against Phythophthora Infestants and Silver Scurf infections and to cure them from such infection. It is also suitable to protect and cure grapevines against/from Plasmopara Viticola.

Living plant tissue can be contacted directly with the aqueous formulation without substantially affecting the health of the living tissue.

The formulation provides antibacterial activity against a wide variety of microorganisms, such as gram positive (e.g., Staphylococcus aureus) and gram negative (e.g., Escherichia coli, salmonella, etc.) microorganisms, yeast, molds, bacterial spores, etc, including Phythophthora Infestants and Plasmopara Viticola.

The formulation with which the plant tissue is treated preferably comprises 0.00001-5.0 wt %, more preferably 0.0001 to 1.0 wt %, and most preferably 0.0003 to 0.2 wt % of the diacyl peroxide.

The formulation preferably comprises 0.00001-1.0 wt %, more preferably 0.0001 to 0.2 wt %, and most preferably 0.001 to 0.05 wt % of the hydroperoxide.

Diacyl peroxides have the general formula R—C(═O)—O—O—C(═O)—R, wherein R is an aliphatic or aromatic hydrocarbon moiety, optionally substituted with one or more alkyl groups and/or hetero-atom containing groups.

Particularly suitable diacyl peroxides are dibenzoyl peroxide, di(methylbenzoyl)peroxide (e.g. di(4-methylbenzoyl)peroxide), and dilauroyl peroxide.

If the diacyl peroxide is solid at room temperature, the formulation has the form of a suspension. The diacyl particles in said suspension preferably have a d50 particle size in the range 0.01-200 micrometer, more preferably 0.10-100 micrometer, and most preferably 1-10 micrometer, as measured with light scattering using a Malvern Particle Sizer 2600C. The d50 is the value of the particle size which divides the population into two equal halves, i.e. 50 vol % of the distribution is above and 50 vol % is below this value.

This size can be obtained by milling, for instance using a Dispax® (ex-IKA) and/or a pearl mill. A dispersing agent can be present during the milling step.

The aqueous formulation contains hydrogen peroxide and/or an organic hydroperoxide. Organic hydroperoxides include cycloalkyl, aralkyl, and alkyl hydroperoxides. More specific examples include t-butyl hydroperoxide, t-amyl hydroperoxide, t-hexyl hydroperoxide, 1,1,3,3-tetramethylbutyl hydroperoxide, cumene hydroperoxide, cymene hydroperoxide, p-menthane hydroperoxide, pinane hydroperoxide, limonene hydroperoxide, 1-methylcyclohexyl hydroperoxide, 1-methylcyclopentyl hydroperoxide, 3-hydroperoxy-3-methylbutyne-1, 2-hydroperoxy-2-methyl-4-hydroxypentane, 1-hydroperoxycyclohexylacetylene, 2,5-dimethyl-2,5-dihydroperoxyhexane, 2,7-dimethyl-2,7-dihydroperoxyoctane, 2,5-dimethyl-2,5-dihydroperoxyhexyne-3, diisopropylbenzene monohydroperoxide, diisopropylbenzene dihydroperoxide, and ketone peroxides, in particular methyl ethyl ketone peroxide.

More preferred organic hydroperoxides are pinane hydroperoxide, p-menthane hydroperoxide, limonene hydroperoxide, t-butyl hydroperoxide, t-amyl hydroperoxide, cumyl hydroperoxide, and methyl ethyl ketone peroxide.

The most preferred hydroperoxide, however, is hydrogen peroxide, because this allows the formulation to minimise toxic effects to agricultural workers or consumers.

Various optional materials may be added to the formulation in order to restrict or enhance the formation of foam, to control water hardness, to stabilize the formulation or the peroxides, to improve wetting of the plant tissue, to improve adhesion to the plant tissue, to further enhance the antimicrobial activity of the composition, its color or odour, the viscosity, the rainfastness, the thermal (i.e., freeze-thaw) stability, etc.

Surface active agents may act as emulsifier or dipersant and may at the same time improve wetting of the plant tissue with the formulation. Suitable surface active agents for use in the formulation according to the invention include all nonionic, anionic, zwitterionic, and cationic surface active agents that are conventionally used for the formulation of agrochemical active compounds, with a preference to nonionic or anionic dispersants, or mixtures thereof.

Suitable nonionic dispersants are ethylene oxide/propylene oxide block polymers, polyvinyl alcohol/polyvinyl acetate copolymers, acrylic graft copolymers, alkyl polyglycosides, alkoxylated fatty alcohols, alkoxylated alkyl phenols, alkoxylated aryl or polyaryl phenols, alkoxylated amines, alkoxylated mono-, di-, or triglycerides, polyvinyl pyrrolidinones, alkenyl succinic acid diglucamides, and cellulose derivatives such as hydroxymethyl cellulose.

Suitable anionic dispersants are lignosulphonates, naphthalene formaldehyde condensates, polyacrylic acid salts, arylsulphonate/formaldehyde condensates, polystyrene sulphonates, maleic anhydride-methyl vinyl ether copolymers, phosphate ester surfactants such as a tristyrenated phenol ethoxylate phosphate ester, maleic anhydride-diisobutylene copolymers, anionically modified polyvinyl alcohol/polyvinylacetate copolymers, alkali metal fatty acid salts, including alkali metal oleates and stearates, alkali metal lauryl sulphates and sulphonate, alkali metal salts of diisooctyl sulphosuccinate, alkylaryl sulphates and sulphonates including sodium dodecylbenzyl sulphonate and alkylnaphthalene sulphonates like diisopropyl or diisobutyl naphthalenesulphonates, sodium sulphonated alkyl carboxylates, N-methyl-N-oleyoyltaurate, octylphenoxy polyethoxy ethanol, and nonylphenoxy polyethoxy ethanol.

Antifoaming agents include silicone antifoams such as polydimethylsiloxanes, magnesium stearate, mono-, di-, and trialkyl phosphate esters of aliphatic C₈₋₁₂ linear alcohols, and perfluoroalkylphosphonic or -phosphinic acids.

Examples of suitable preservatives are dichlorophene and benzyl alcohol hemiformal.

Cellulose derivatives, acrylic acid derivatives, xanthan, modified clays, and finely divided silica may be added as thickeners.

Examples of colorants that may be present in the formulation include the dyes known by the names Rhodamine B, C.I. Pigment Red 112 and C.I. Solvent Red 1.

Examples of adhesives are polyvinylpyrrolidone, polyvinyl acetate, polyvinyl alcohol, and tylose.

Chelating agents can be added to the formulation in order to enhance biological activity, cleaning performance, and stability of the formulation. Chelating agents enhance the stability of the peroxides by sequestering ions that may catalyse hydroperoxide decomposition. Chelating agents are preferably present in the formulation at levels of from 0.005 to 1.0 wt %.

Examples of suitable chelating agents are 1-hydroxyethylidene-1,1-diphosphonic acid, aminopolyphosphonates, such as ethylenediamine tetramethylene phosphonic acid, diethylene triamine pentamethylenephosphonic acid, and their sodium or potassium salts, quinolines, picolinic acid, dipicolinic acid, alkyl phosphates, alkyl phosphonates, aminophosphates, amino carboxylates (e.g. NTA, EDTA, PDTA), di- or polycarboxylates (e.g. polycitric acid, polyacrylate, or styrene maleic acid copolymers), sodium stannate, and aluminosilicates such zeolite A and hydrated zeolite A.

In addition, an anhydride may be added to the formulation, such as acetic anhydride or phthalalic anhydride.

The formulation can be applied to growing plant tissue by a variety of techniques. The formulation can be sprayed, painted, daubed, fogged, or flooded onto the plant, the plant hydroponic substrate, the agricultural earth, seeds, tubers, fruit, cuttings, or rooting stock. The material can be re-applied periodically—for instance on growing plants—as needed.

The formulation can be applied to field, hydroponic or greenhouse growing plant tissue, in growing media and containers. It is especially suitable as preventative and curative agent against diseases inflicted by wet circumstances.

Examples of plants are tomato's, potato's, cucumbers, gherkins, and grapes, but also strawberries, blackberries, raspberries, rise, corn, and cerials.

The formulation is particularly effective to protect tomato's and potato's against Phythophthora infestans and grapevines against Plasmopora Viticola; both as preventative and curative measure. Plasmopora Viticola causes downey mildew. Other diseases of grapevines that can be cured and prevented by the method according to the present invention include black rot, powdery mildew, botrytis rot, bitter rot, and anthracnose.

The concentration in which the formulation has to be applied on the plant tissue is preferably in the range 0.001-50 kg, more preferably 0.003-25 kg, and most preferably 0.01-10 kg per hectare, depending on the type of plant tissue.

The formulation may be applied on the plant tissue alone, or in combination with one or more other fungicides.

### EXAMPLES

In four experiments, the following aqueous formulations were prepared and applied on tomato plants.

In Comparative Experiment 1, a formulation containing 11.5 wt % perglutaric acid (PGA) and 27 wt % H₂O₂ was prepared and subsequently diluted 1578 times with water.

In Comparative Experiment 2, a formulation containing 11.5 wt % perglutaric acid and 27 wt % H₂O₂ was prepared and subsequently diluted 157.8 times with water.

In Experiment 3, a formulation containing 9.9 wt % dibenzoyl peroxide with an average particle size (d50) of 4 microns and 0.71 wt % hydrogen peroxide was prepared and subsequently diluted 40 times with water.

In Experiment 4, a formulation containing 9.75 wt % dibenzoyl peroxide (BPO) with an average particle size (d50) of 4 microns, 0.28 wt % perglutaric acid and 0.67 wt % H₂O₂ was prepared and subsequently diluted 40 times with water. The formulations of experiments 3 and 4 were prepared by milling BPO, followed by adding the other ingredients.

The tomato plants were grown in an artificial substrate (glass wool). Per glass wool block, one tomato plant was planted. The trial was executed in 3 replicates. Each replicate counted 3 tomato plants.

The plants were artificially inoculated (crop height around 40 cm) with 5.000 P. infestans spores per ml. Each plant was sprayed with 5 ml inoculum (25.000 spores/plant).

The trial consisted of 5 fungicide treatments, 3 application intervals before inoculation and 2 application intervals after inocculation and three replicates. The formulations were applied in the amounts given above. Ethylan 1008 was added prior to their application in an amount which resulted in an Ethylan 1008 coverage 0.9 l/ha.

Application interval before inoculation: 7 days, 3 days and 1 day

Application interval after inoculation: 12 and 36 hours

Single applications were carried out. The spray volume was 300 l/ha and the pressure was 2.5 bar. The nozzles were placed at a distance of 50 cm.

The assessment was done 8 days after the inoculation. During the assessment event, the inoculated and also sprayed leaf layers were monitored on the visual presence of P. infestans. The two highest treated leaf layers were assessed. Tables 1 and 2 show the results of this trial.

TABLE 1
Infection level (%) of P. infestans in the foliage (tomato plants) after
singular treatments on three dates before artificial inoculation.
The infection level in the untreated plants was 21%. Presented is the
average of 3 replicates.

| | 7 days before | 3 days before | 1 day before |
|---|---|---|---|
| experiment | inoculation | inoculation | inoculation |
| 1 (comp) | 20 | 16.9 | 12.8 |
| 2 (comp) | 23.6 | 18.1 | 8.9 |
| 3 | 6.5 | 3.6 | 1.1 |
| 4 | 9.7 | 5.1 | 0.8 |

These results show that the best preventive protection is obtained with formulations comprising BPO and hydrogen peroxide.

TABLE 2
Infection level (%) of P. infestans in the foliage (tomato plants)
after singular treatments on two dates after artificial inoculation.
The infection level in the untreated plants was 21%. Presented is the
average of 3 replicates.

| | 12 hours after | 36 hours after |
|---|---|---|
| experiment | inoculation | inoculation |
| 1 (comp) | 8.9 | 8.0 |
| 2 (comp) | 1.1 | 25.6 |
| 3 | 16.4 | 7.7 |
| 4 | 14.6 | 10.5 |

These results show that the best curative protection is obtained with a combination of BPO and hydrogen peroxide.

1. A method of controlling microbial pathogens on living plant tissue comprising treating said plant tissue with an aqueous formulation comprising a diacyl peroxide and a hydroperoxide selected from hydrogen peroxide and organic hydroperoxides.

2. The method according to claim 1 wherein the hydroperoxide is hydrogen peroxide.

3. The method according to claim 1, wherein the aqueous formulation comprises
(a) 0.00001-5.0 wt % of the diacyl peroxide and
(b) 0.00001-1.0 wt % of the hydroperoxide.

4. The method according to claim 1 wherein the aqueous formulation is an aqueous suspension.

5. The method according to claim 1 wherein the diacyl peroxide is dibenzoyl peroxide.

6. The method according to claim 1 wherein the diacyl peroxide is di(4-methylbenzoyl) peroxide.

7. The method according to claim 1 wherein the diacyl peroxide is dilauroyl peroxide.

8. The method according to claim 1 wherein the diacyl peroxide has a d50 particle diameter in the range 0.01-200 micrometers.

9. The method according to claim 1 wherein the plant tissue is a seed, a tuber, a cutting, a growing plant, or a rooting stock.

10. The method according to claim 1 wherein the plant tissue is potato plant tissue.

11. The method according to claim 1 wherein the plant tissue is tomato plant tissue.

12. The method according to claim 1 wherein the plant tissue is grapevine plant tissue.

13. A method for the treatment of tomato plants against Phythophthora Infestans by treating said plants with an aqueous formulation comprising a diacyl peroxide and a hydroperoxide selected from hydrogen peroxide and organic hydroperoxides.

14. A method for the treatment of potato plants against Phythophthora Infestans by treating said plants with an aqueous formulation comprising a diacyl peroxide and a hydroperoxide selected from hydrogen peroxide and organic hydroperoxides.

15. A method for the treatment of grapevines against Plasmopora Viticola by treating said plants with an aqueous formulation comprising a diacyl peroxide and a hydroperoxide selected from hydrogen peroxide and organic hydroperoxides.
